(19) United States
(12) Patent Application Publication
(10) Pub. No.: US 2014/0193738 A1
(43) Pub. Date: Jul. 10, 2014

(54) CELL FOR FUEL-CELL BATTERY USING A PROTON EXCHANGE MEMBRANE, WITH GAS DIFFUSION LAYERS OF DIFFERENT RIGIDITY AT THE ANODE AND AT THE CATHODE

(71) Applicant: COMMISSARIAT A L'ENERGIE ATOMIQUE ET AUX ENERGIES ALTERNATIVES, Paris (FR)

(72) Inventors: Ludovic ROUILLON, VILLARD DE LANS (FR); Joel PAUCHET, SAINT MARTIN D'URIAGE (FR)

(21) Appl. No.: 14/101,218

(22) Filed: Dec. 9, 2013

(30) Foreign Application Priority Data
Dec. 10, 2012 (FR) 12 61834

(51) Int. Cl. H01M 8/10

(52) U.S. Cl. CPC H01M 8/1004
USPC 429/465; 429/480

(57) ABSTRACT

A cell structure for a fuel-cell battery, which allows the compromise necessary between the reduction in the non-uniformities of mechanical stress to be optimized, with the aim of obtaining a more uniform operation, and the independent accommodation with respect to the defects in planarity/thickness/alignment, while at the same time meeting the compactness constraint, comprises: a membrane/electrode assembly comprising a first electrode and a second electrode separated by a membrane; a gas diffusion layer stacked on each face of the assembly, between an electrode of the assembly and a current collector plate; and the gas diffusion layers stacked on either side of the assembly do not have the same rigidity, one of the gas diffusion layers having a Young's modulus relative to an applied stress in the direction of the thickness, greater than the Young's modulus of the other layer, in a ratio of the order of at least 100.

### CROSS-REFERENCE TO RELATED APPLICATION

This application claims priority to foreign French patent application No. FR 1261834, filed on Dec. 10, 2012, the disclosure of which is incorporated by reference in its entirety.

### FIELD OF THE INVENTION

The present invention relates to fuel cells for the generation of electricity, and more particularly those cells referred to as proton exchange membrane fuel cells, known by their acronym PEMFC. The invention more particularly relates to the gas diffusion layer disposed on either side of the membrane-electrode assembly, known as MEA, which constitutes what is commonly called the battery core of these cells.

### BACKGROUND

A PEMFC battery is a current generator whose principle of operation rests on the conversion of chemical energy into electrical energy by catalytic reaction of hydrogen and oxygen. A battery comprises at least one cell, but more generally a series stack of several cells, in order to meet the needs of the applications.

Each cell Cᵢ comprises a membrane-electrode assembly (MEA) commonly called the battery core which constitutes the basic element of the PEMFCs. As illustrated schematically in FIG. 1, a membrane-electrode assembly MEA is composed of an electrolytic membrane Mᵢ and of two electrodes Aᵢ and Bᵢ one on either side of the membrane, respectively forming an anode and a cathode. The membrane thus separates the catalytic compartments, anode and cathode, of the cell. The cell also comprises a gas diffusion layer GDL_{Ai} and GDL_{Bi} (carbon tissue, felt, etc.), one on the anode side and one on the cathode side, in order to provide the electrical conduction, the uniform arrival of the reactive gases and the evacuation of the water produced. Each gas diffusion layer is stacked between an electrode of the assembly MEA and a collector plate for a respective current. The two plates Pᵢ and Pᵢ₊₁ that flank the assembly have the additional function of current collector, a function of fluid transport, for the distribution of the reactive agents, fuel on the anode side and oxidizer on the cathode side and the outflow of the water or the water vapour produced. These plates thus have a wall (r) structured for forming transport channels. The plate is said to have a tooth/channel structure or geometry.

A battery is illustrated schematically in FIG. 2 which comprises a stack of n=3 cells. Each cell comprises a multilayer structure: gas diffusion layer /MEA/gas diffusion layer (GDL_{A}/MEA/GDL_{B}), between two current collector plates. The outermost plates P₁ and P₄ serve as clamping plates for the mechanical holding of the assembly. The inner plates of the multilayer structure, the plates P₂ and P₃ in the example, each serve two cells of the stack, with one wall applied on the anode side of a cell, and the other wall applied on the cathode side of another cell (bipolar plates).

The most common current collector plates are plates made of graphite and the outflow channels are obtained by machining, but other types of plates have been developed in order notably to reduce their costs. Thus, for example, plates made of organic composite materials obtained by thermo-compression, or using rolled metal plate can be found. As previously indicated, one or both of their faces have a geometrical relief structure tracing the fluid transport channels. This structured face, said to have teeth and channels, rests against a gas diffusion layer disposed on one face of an MEA. The transport channels are thus bounded by the plate and the gas diffusion layer. The teeth of the plates, which are the parts resting against the gas diffusion layers, are the current collection points for the plates.

The electrolytic membrane is a thin polymer membrane, allowing the passage of the protons (H⁺) but impermeable to the reactive agents.

The electrodes are formed by at least one catalytic layer. The catalytic layers are the active layers of the battery core. They are porous, generally composed of nano-particles of platinum which form the catalytic sites, supported by carbon aggregates.

The gas diffusion layers are composed of a porous material such as carbon fibre paper or tissue. As previously indicated, they provide the electrical conduction, the arrival of the reactive agents brought via the channels of the plates and their distribution as uniform as possible in the active layer and the evacuation of the water produced by the chemical reaction. These layers are also used to compensate for the alignment, planarity and thickness defects of the various components of the stacked cells held by mechanical compression via the clamping plates.

The clamping force is determined so as to adjust the compression Fc exerted by each pair of plates on each of the assemblies MEA of the stack. A certain compression is indeed necessary for the mechanical assembly itself but also in order to achieve an optimum conductivity within each cell by favouring the pathways for electrical and thermal conduction between the components of the assemblies MEA and the current collection points, in other words typically the teeth of the plates, in order to compensate for the effects of the thermal expansion coefficients of the layers of the assembly MEA observed notably in the start up and power down phases, or in the case of a variation in the load of the battery and for compensating for the alignment/planarity/thickness defects of the stack of cells.

### Problem Posed

Numerous research and development efforts are underway for improving the performance characteristics of fuel cells and also for reducing their costs, with the aim of enabling their deployment on the industrial scale, notably for transport applications.

With regard to one cell, it is sought to optimize each of the components, and notably those of the battery core or MEA: the membrane, the active layers and the diffusion layers, which thus form the object of specific studies (materials, structure).

One axis of these studies relates to the well-known non-uniformities in operation of these batteries, associated with the manner in which mechanical stresses are exerted on the components of the cells of the stack of a battery.

From the point of view of a cell Cᵢ, as illustrated in FIG. 3, a mechanical stress is exerted on the diffusion layers Aᵢ and Bᵢ of the assembly MEA which results from the compression force Fc applied by the clamping plates (FIG. 2). This mechanical stress is exerted in reality in a more or less non-uniform manner, depending on the material of the gas diffusion layer. It has indeed been seen that the plate wall, which rests against a gas diffusion layer, exhibits a surface structured in relief in such a manner as to form outflow channels between the plate wall and this layer. By the action of the clamping plates, the plate exerts a compressive stress on the gas diffusion layer. Owing to the geometry of the wall and to the difference in terms of rigidity between the materials composing the plate and the gas diffusion layer, this mechanical stress does not spread itself in a uniform manner over the diffusion layer. More precisely, the stress is localized under the parts of the plate resting against the layer, in other words typically under the teeth. Under the channels, the gas diffusion layer does not see any stress and can therefore be distended as illustrated in FIG. 3, notably under the effect of the water produced in the reactions.

This non-uniformity in compression is all the more marked the more flexible the gas diffusion layer. A mapping of the stresses exerted on a gas diffusion layer would thus clearly show an impression of the teeth within the layer, which would be more marked for diffusion layers of the felt type than for those of the paper type.

However, as illustrated in FIG. 4, the gas diffusion layers of the cells, such as the layer GDLAᵢ in the figure, provide the electrical conduction to the collectors (teeth) of the plates (Pᵢ), the arrival of the reactive agents brought by the channels traced by the plates and their distribution within the active layer, which should be as uniform as possible in order to reach the catalytic sites distributed within the catalytic layer A and the evacuation of the water or the water vapour produced by the chemical reaction.

These layers are furthermore used to compensate for the alignment, planarity and thickness defects of the various components of the stacked cells held by mechanical compression via the clamping plates.

The stress from mechanical compression which is exerted in a non-uniform manner on the surface of the gas diffusion layer therefore results, on each cell, in a non-uniform operation with two main effects:
The porosity of the gas diffusion layer is higher under the channels than under the teeth, where the compression of the diffusion layer is greatest. The gases will therefore diffuse preferentially toward the catalytic sites situated under the channels, since they are more accessible.
The electrical conductivity is higher under the teeth, the compression favouring the electrical conduction pathways within the layer, and hence it is through the teeth that the electrons are principally collected.

This non-uniformity of operation therefore sets limits on the electrical transfer, on the one hand, and on the transfer of gas, on the other.

From the point of view of the battery comprising a stack of cells held between two clamping plates, other mechanical non-uniformities are to be taken into account which contribute to the non-uniformities in operation within the cells; these are the non-uniformities in alignment, in thickness and in planarity of the various components. These non-uniformities have a tendency to increase owing to a relaxing in the tolerance demands associated with the quest for a reduction in manufacturing costs.

All the efforts deployed for improving the performance characteristics and reducing the manufacturing costs with the objective of achieving energy production costs compatible with the expectations of the market take into account these various non-uniformities from different viewpoints.

Some solutions thus include taking advantage of this non-uniformity of operation, in particular, by using techniques of non-uniform distribution of the catalyzer, in other words preferably under the channels where the diffusion of the reactive agents is promoted. However, these techniques of controlled catalyzer non-uniform distribution are costly.

Other solutions seek, in contrast, to render this operation more uniform, by using materials which also remain uniform, hence in principle simpler and less costly to produce. The problem that is then posed is how to render the mechanical stress more uniform, with the goal of rendering the operation within the cells more uniform.

Some solutions relate to the relief structure of the walls of the plates which form the fluid transport channels. In other words, these solutions concentrate on the geometry of the teeth/channels.

Other solutions seek to render more uniform, in terms of mechanical stress, the materials on which these stresses are exerted, in such a manner that the stress exerted in compression spreads itself out in a substantially uniform manner over the whole surface of these components. In this scenario, some solutions provide for the plate wall, on which the fluid transport channels are formed by structuring of the surface with relief, to be formed in a porous material of the foam type.

Others, on the other hand, provide for the stacking between the assembly MEA and the plates to be rigidified. For example, the application WO2007/008402 or the Patent U.S. Pat. No. 6,007,933 suggest the addition, on either side of the MEA, of an intermediate rigid layer between a flexible gas diffusion layer and the plate wall in order to promote the uniform distribution of the compressive stress.

This intermediate layer must be conducting in order to allow the electrical conduction pathways between the gas diffusion layer and the current collector plate, and must not interfere with the functions of transport of gas and of outflow of water. The Patent U.S. Pat. No. 6,007,933 teaches in this regard that the intermediate layer can be a layer of a expanded, etched or woven metal, a perforated foil or else a screen.

These intermediate layers increase the thickness of the cells. This increase in thickness is a serious drawback, notably when the battery is a stack of cells in series, in order to form a high-power battery, owing to the stringent demands of the market in terms of compactness.

### SUMMARY OF THE INVENTION

The aim of the invention is to provide a cell structure for a fuel-cell battery, which allows the compromise necessary between the reduction in the non-uniformities of mechanical stress to be optimized, with the aim of obtaining a more uniform operation, and the independent accommodation with respect to the defects in planarity/thickness/alignment, while at the same time meeting the compactness constraint.

In order to achieve this, the idea of the invention is to move away from completely symmetrical structures of the prior art, in which there are layers and a stack of these layers that are identical on either side of the membrane, and to provide a cell in which a gas diffusion layer is more rigid on one side of the membrane than on the other, in a ratio of at least around one hundred.

The invention thus relates to a cell for a fuel-cell battery, comprising:
a membrane/electrode assembly comprising a first electrode and a second electrode separated by a membrane,
a gas diffusion layer stacked on each face of the assembly, between an electrode of the assembly and a current collector plate,
characterized in that the gas diffusion layers stacked on either side of the assembly do not have the same rigidity, one of the gas diffusion layers having a Young's modulus relative to an applied stress in the direction of the thickness, greater than the Young's modulus of the other layer, in a ratio of the order of at least 100.

Since the gas diffusion layers are porous layers made of carbon fibre, the rigidity is ajusted in a simple manner by the quantity of binder, resin for example for layers composed of carbon fibres.

The invention can thus be easily applied to the battery cells already well known and characterized, by simply adapting the quantity of binder contained in one of the gas diffusion layers so as to obtain the desired rigidity.

Preferably, it is the gas diffusion layer on the cathode side which is chosen to be the most rigid, which endows it with a function of rendering the mechanical stresses more uniform. The gas diffusion layer on the anode side, which is more flexible, allows the function of accommodation of the assembly to the planarity/thickness/alignment defects in the stack of cells of the battery to be provided.

The cell thus formed has a component, the gas diffusion layer, which, on one side, provides the function of making effects of the compressive stress uniform, which has the technical effect of rendering the operation of the cell uniform, and which, on the other side, provides the function of independent accommodation to the defects in planarity/thickness/alignment.

Advantageously, it was able to be demonstrated by numerous tests on stacks composed according to the invention, by varying the rigidity of the most rigid layer, that the best results are obtained with a rigid gas diffusion layer whose modulus of elasticity or Young's modulus, considered in the direction of the axis of stacking corresponding to the axis following which the compression force is exerted, is in the range between a few thousand and a few hundred thousand megapascals (MPa). It is preferably in the range between a few thousand and a few tens of thousands of megapascals, and preferably in the range between around 5700 MPa and around 58000 MPa. Preferably, the least rigid diffusion layer has a Young's modulus which is around 70 megapascals.

The invention is applicable to a fuel-cell battery formed from a stack of cells comprising gas diffusion layers with different rigidities at the anode and at the cathode according to the invention.

The invention can be implemented in a simple manner, and is advantageously applicable to cells whose components are already well defined and used in fuel cells, by simply modifying the rigidity of one of the gas diffusion layers.

### BRIEF DESCRIPTION OF THE DRAWINGS

Other features and advantages of the invention will become apparent upon reading the detailed description that follows and which is presented with reference to the appended drawings in which:

FIG. 1 shows schematically the components of a cell of a fuel-cell battery;

FIG. 2 is a diagram of a fuel-cell battery comprising a stack of several cells;

FIG. 3 illustrates the structural differences induced on the gas diffusion layers of a cell, owing to the geographical regions being more compressed (under the teeth of the plate) than others (under the channels);

FIG. 4 is a cross-sectional view of an electrode-membrane assembly, with a plate wall applied in compression onto the gas diffusion layer, demonstrating the electrical, gaseous and water or water vapour transfers within a catalytic compartment of a cell;

FIG. 5 shows various curves obtained by simulation, showing the distribution of stress within a cell according to the invention, as a function of the rigidity of the most rigid gas diffusion layer; and

FIG. 6 allows the effects on the distribution of the local current density to be illustrated as a function of the overall current density within a cell, depending on whether the gas diffusion layers of the cell are identical and flexible (a), one flexible the other rigid according to the invention (b), or identical but rigid (c).

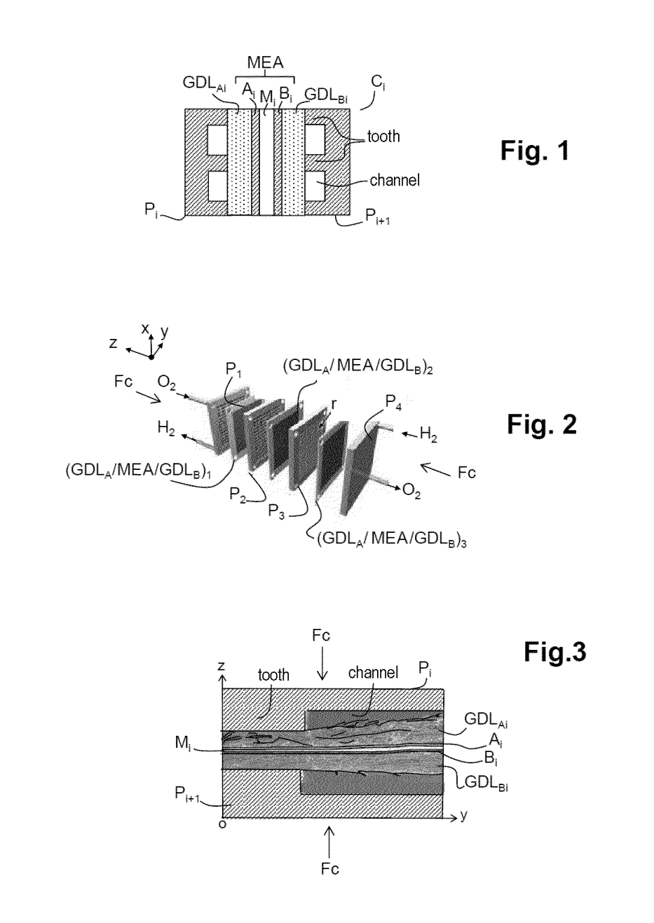

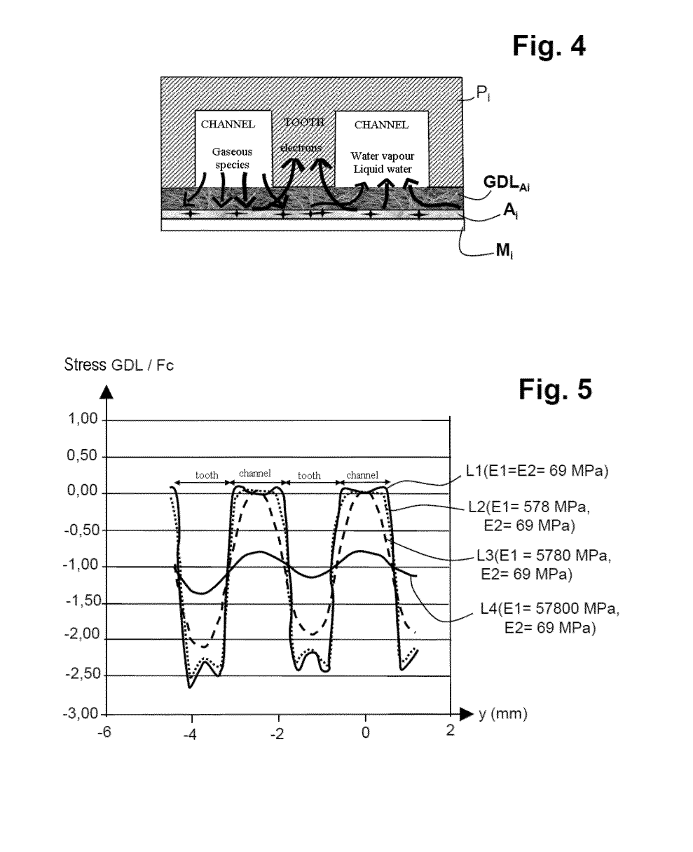

### DETAILED DESCRIPTION

The invention consists in using a gas diffusion layer that is more rigid on one face of the assembly MEA than on the other.

As already presented hereinbefore, in the invention, the rigidity is understood to be relative to a compressive stress, in other words a stress which is exerted along the axis of stacking of components of the cell, in other words in the direction of the thickness of the layers.

The rigidity of the layer is characterized by the value of the Young's modulus of this layer. This is of course the Young's modulus relative to the compressive stress which is exerted. In the figures, this axis is the axis z, the axes x and y indicated in the figures being those of the surface planes of the stacked layers. This is not re-stated in the following description.

According to the invention, the most rigid layer has a Young's modulus at least around one hundred times higher than that of the other layer.

Preferably, the most rigid layer is that on the cathode side, because it is here that the current density is the highest as is the quantity of water which tends to distend the gas diffusion layer under the channels (FIG. 3). Notably, a stress exerted more uniformly over the whole surface of this layer will prevent it from distending, and will improve the electrical conduction pathways under the channels.

In one exemplary embodiment of the invention, by taking as an example gas diffusion layers composed of carbon fibres contained in a binder, typically a resin, the quantity of binder normally used is increased for one layer, in order to obtain the desired rigidity.

Thus, by using a rigid gas diffusion layer on one side of an assembly MEA and a flexible gas diffusion layer on the other side of this assembly, such as has just been stated, it is shown that the distribution of the mechanical compressive stress tends to be made uniform and that its operation is correspondingly made more uniform.

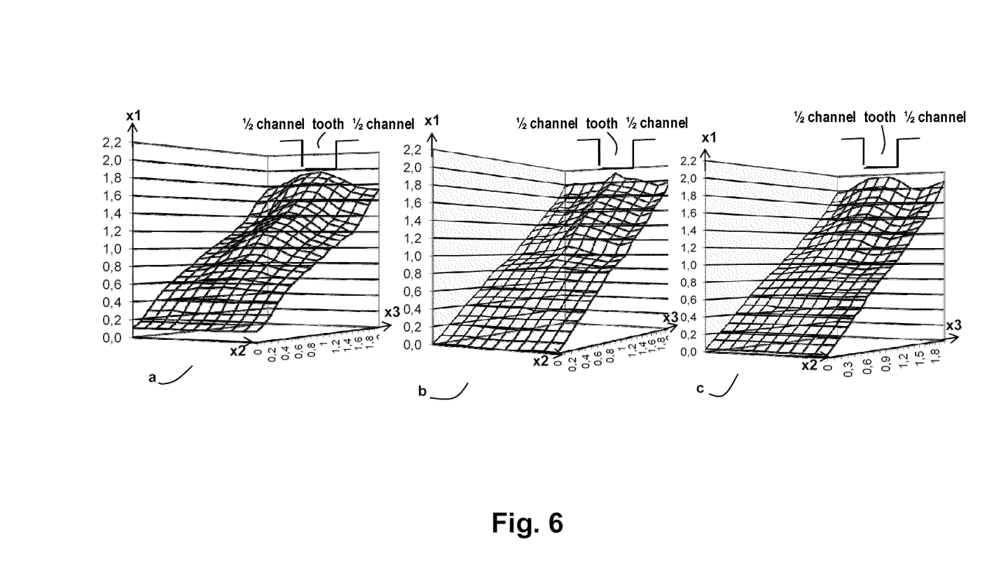

This is what is illustrated in FIGS. 5 and 6.

FIG. 5 shows simulation curves of the stress distribution for various couples of Young's modulus for the gas diffusion layers of a cell, along a series of teeth and channels (along the oy axis, on the abscissa). The axis of the ordinates indicates the ratio (without units) of the stress measured on the gas diffusion layer over the compression force Fc applied via the plates.

The first curve L1 corresponds to a cell of the prior art with two identical gas diffusion layers, having a standard Young's modulus for these layers, fixed at 69 MPa for the simulation.

It shows a completely non-uniform distribution of stress, with a ratio stress over compression force of zero under the channels, and maximum, of around −2.50, under the teeth.

The second curve L2 shows that a rigidity raised by a ratio of 10 in the example, for one of the layers, does not produce any notable effects on the distribution of the stress.

The third curve L3 shows a notable change, with a curve of distribution that, instead of the crenulated form of the two preceding curves, substantially corresponding to the relief traced of the plate, takes a sinusoidal form, in other words a stress which increases and decreases in a sinusoidal manner along the z axis, with peak amplitudes situated substantially in the middle of the channels and of the teeth.

The fourth curve L4 shows a greater improvement in this distribution, still with a sinusoidal shape, but with a much lower amplitude since the curve L3 extended between ratios of stress over compression force oscillating between around −2.10 and 0.00 and the curve L4 extends between ratios of stress over compression force oscillating between around −1.40 and −0.90. It is obtained with a rigidity 1000 times greater than that of the other layer.

FIG. 6 demonstrates the effects of a more uniform distribution of the stress by rigidification of one or of both gas diffusion layers. It shows the distribution of local current density along a half-channel/tooth/half-channel pattern (following the oy axis, on the abscissa), as a function of the overall current density, which is varied across the terminals of a cell.

These curves are obtained in a known manner by placing conducting microwires under the teeth and the channels of a plate, between the plate and a gas diffusion layer. The plates of the cell are connected to a variable electrical charge, typically a galvanostat, which enables a wide range of current to be scanned, and hence of overall current density (equal to the value of the current transferred to the surface of the battery core). A potential difference is measured on each of the wires, and based on an electrical model of the battery, the local current density is deduced. A well-known technique makes use of the Laplace equation for subsequently injecting the values obtained in an electrical simulation model as explained for example in the following publication: by Stefan A. Freunberger et al., “Measuring the current distribution in PEFCs with sub-millimeter resolution” Journal of Electrochimical Society, 153 (11) A2158-A2165 (2006).

FIG. 6 shows the mapping obtained depending on whether the cell has two identical and flexible gas diffusion layers, one rigid diffusion layer and the other flexible, according to the invention, or again two rigid layers, for a cell with an otherwise identical plate structure, namely, with tooth widths of 0.8 mm and channel widths of 1.4 mm, and a current density of 1.5 A/mm². The axis x1 is the axis of the local current density in Amps per square centimetre, the axis x2 is the axis giving the position of the succession of teeth and channels along the y axis of the geometry of the cells, in millimetres. Lastly, the axis x3 gives the overall current density, in Amps per square centimetre.

The map “a” in the figure, which corresponds to a conventional cell with “naturally” flexible gas diffusion layers, shows that the difference in the local current density between a tooth and a channel increases with the increase in the overall current density.

By using a rigid gas diffusion layer, as specified in the invention, in the multilayer structure of the cell, it can be seen that this difference decreases greatly for overall current densities greater than 0.5 Amps per square centimetre, corresponding to what is required for applications of fuel-cell batteries.

In a more detailed manner, for an assembly according to the invention with one flexible gas diffusion layer and the other rigid, the non-uniformity of operation is greatly reduced, and only starts from 1 Amp per square centimetre. The solution of the invention therefore offers a range of uniform, or substantially uniform, operation for the range of overall current density sought for the applications of batteries.

Furthermore, the non-uniformity in local current density is localized under the tooth, over a width of 0.4 mm for a cell with gas diffusion layers, one flexible the other rigid according to the invention (curve b), compared with 1 mm in the case where both are rigid (curve c).

The uniformity of local current density promotes a uniform distribution of the water produced. In the opposite case, there is an accumulation of water under the tooth and the transfer of gas becomes impossible for higher current densities, leading to a shutdown of the battery.

Thus, the invention described and claimed allows the non-uniformities in operation associated with the mechanical tooth/channel effect of the gas distributors to be reduced, while at the same time enabling an independent accommodation for a stack of components as a high-power battery, in order to overcome the non-uniformities in alignment, planarity and thickness of the components.

It is readily applicable to battery components that have already proved their worth, it does not generate any thickness excesses, and does not degrade either the thermal functions or the electrical functions of the gas diffusion layers.

1. A cell for a fuel-cell battery, comprising:
a membrane/electrode assembly comprising a first electrode and a second electrode separated by a membrane, and
a gas diffusion layer stacked on each face of the assembly, between an electrode of the assembly and a current collector plate,
wherein the gas diffusion layers stacked on either side of the assembly do not have the same rigidity, one of the gas diffusion layers having a Young's modulus relative to an applied stress in the direction of the thickness, greater than the Young's modulus of the other layer, in a ratio of the order of at least 100.

2. The cell according to claim 1, wherein the most rigid gas diffusion layer is that stacked on the electrode of the assembly which forms a cathode.

3. The cell according to claim 1, wherein the most rigid diffusion layer has a Young's modulus greater than at least a few thousand megapascals.

4. The cell according to claim 1, wherein the most rigid diffusion layer has a Young's modulus in the range between a few thousand megapascals, and a few tens of thousands of megapascals, and preferably in the range between around 5700 megapascals and around 58000 megapascals.

5. The cell according to claim 1, wherein the least rigid diffusion layer has a Young's modulus which is around 70 megapascals.

6. The cell according to claim 2, wherein the most rigid diffusion layer has a Young's modulus greater than at least a few thousand megapascals.

7. The cell according to claim 2, wherein the most rigid diffusion layer has a Young's modulus in the range between a few thousand megapascals, and a few tens of thousands of megapascals, and preferably in the range between around 5700 megapascals and around 58000 megapascals.

8. The cell according to claim 2, wherein the least rigid diffusion layer has a Young's modulus which is around 70 megapascals.

9. A fuel-cell battery comprising a stack of one or more cells according to claim 1.
